(19) United States
(12) Patent Application Publication
(10) Pub. No.: US 2007/0173093 A1
(43) Pub. Date: Jul. 26, 2007

(54) Insertion device

(75) Inventors: Yasuhito Kura, Tokyo (JP); Katsutaka Adachi, Tokyo (JP)

Correspondence Address: Thomas Spinelli;Scully, Scott, Murphy & Presser, Suite 300, 400 Garden City Plaza, Garden City, NY, 11530, US

(73) Assignee: Olympus Corporation, Tokyo (JP)

(21) Appl. No.: 11/728,484

(22) Filed: Mar. 26, 2007

Related U.S. Application Data
(63) Continuation of application No. PCT/JP05/15775, filed on Aug. 30, 2005.

(30) Foreign Application Priority Data
Sep. 28, 2004 (JP) 2004-282423

(51) Int. Cl. H01R 29/00

(52) U.S. Cl. 439/188

(57) ABSTRACT

An insertion device includes a flexible insertion portion guiding section formed with a helically shaped portion around the outer circumferential surface thereof, a guiding section rotating device for rotating the insertion portion guiding section in a predetermined direction around the longitudinal axis thereof, and a propulsive force generating device for generating propulsive force in the insertion portion guiding section in the direction of the longitudinal axis of the insertion portion guiding section.

### CROSS REFERENCE TO RELATED APPLICATION

This application is a continuation application of PCT/JP2005/015775 filed on Aug. 30, 2005 and claims benefit of Japanese Application No. 2004-282423 filed in Japan on Sep. 28, 2004, the entire contents of which are incorporated herein by this reference.

### BACKGROUND OF THE INVENTION

1. Field of the Invention

The present invention relates to an insertion device for introducing a medical instrument such as an insertion portion of an endoscope into a body cavity.

2. Description of the Related Art

Conventionally, a medical instrument such as an endoscope has been used in the medical field. The endoscope includes an elongated and flexible insertion portion. Through insertion of the insertion portion into a body cavity, examination, treatment, or the like can be performed in the body cavity.

Generally, the endoscope including the elongated insertion portion is provided with a bending portion at the leading end side of the insertion portion. The bending portion is formed by a plurality of bending pieces rotatably connected to one another to perform a bending operation. The bending portion is bent in the vertical or horizontal directions, for example, as an operation wire connected to the bending pieces which form the bending portion is moved back and forth. The operation wire is moved back and forth as an operator operates to rotate operation means provided to an operation portion, such as a bending knob, for example.

In performing an endoscopic examination, the insertion portion needs to be inserted into the intricate body cavity. For example, the large intestine is an intricate lumen forming a 360° loop. In inserting the insertion portion into the large intestine, the operator operates the bending knob to perform the bending operation of the bending portion, and also performs a hand operation such as a twisting operation of the insertion portion. Thereby, a leading end portion of the insertion portion is introduced toward a site to be observed.

However, considerable skill is required to be able to smoothly introduce the insertion portion into a deep part of the intricate large intestine in a short time without causing pain to a patient. In other words, in inserting the insertion portion toward the deep part, an inexperienced operator may lose the insertion direction and thus take time in the insertion, or may deform the lying shape of the intestine during the insertion of the insertion portion. In light of this, a variety of proposals have been made to improve the insertability of the insertion portion.

For example, Japanese Unexamined Patent Application Publication No. 10-113396 discloses a propelling device for a medical instrument capable of easily guiding the medical instrument into a deep part of a biological lumen with low invasion. In the propelling device, a rotary member is formed with an oblique rib with respect to the axial direction of the rotary member. Therefore, as the rotary member is operated to be rotated, the rotational force of the rotary member is converted into the propulsive force by the rib. Then, the medical instrument connected to the propelling device is moved by the propulsive force toward the direction of the deep part.

### SUMMARY OF THE INVENTION

An endoscope insertion device according to the present invention includes a flexible insertion portion guiding section formed with a helically shaped portion around the outer circumferential surface thereof, a guiding section rotating device for rotating the insertion portion guiding section in a predetermined direction around the longitudinal axis thereof, and a propulsive force generating device for generating propulsive force in the insertion portion guiding section in the direction of the longitudinal axis of the insertion portion guiding section.

### BRIEF DESCRIPTION OF THE DRAWINGS

FIG. 1 is a diagram for explaining an overall configuration of an endoscope system;

FIG. 2 is an external view including a partial cross-sectional view for explaining a configuration of an endoscope in the endoscope system;

FIG. 3 is a cross-sectional view for explaining a configuration of an area near a bend preventing portion of the endoscope;

FIG. 4 is a cross-sectional view for explaining a configuration of a propulsive force generating device in the endoscope system;

FIG. 5 is a diagram for explaining another configuration of a nipping portion included in the propulsive force generating device illustrated in FIG. 4;

FIG. 6 is a diagram for explaining still another configuration of the nipping portion included in the propulsive force generating device illustrated in FIG. 4;

FIG. 7 is a diagram for explaining still yet another configuration of the nipping portion included in the propulsive force generating device illustrated in FIG. 4;

FIG. 8 is a diagram for explaining another configuration of the propulsive force generating device in the endoscope system;

FIG. 9 is a diagram for explaining still another configuration of the propulsive force generating device in the endoscope system;

FIG. 10 is a diagram for explaining a configuration of a propulsive force generating device including an adjusting lever;

FIG. 11 is a diagram for explaining a configuration of a propulsive force generating device including a bend generating stage;

FIG. 12 is a diagram for explaining a guide tube formed by connecting two kinds of guide tubes of different helix angles;

FIG. 13 is a diagram for explaining a guide tube formed by connecting three kinds of guide tubes of different helix angles; and

FIG. 14 is a diagram illustrating a configuration of a medical instrument including a capsule-type observation device disposed at a leading end of a guide tube.

### DETAILED DESCRIPTION OF THE PREFERRED EMBODIMENT(S)

Embodiments of the present invention will be described below with reference to the drawings.

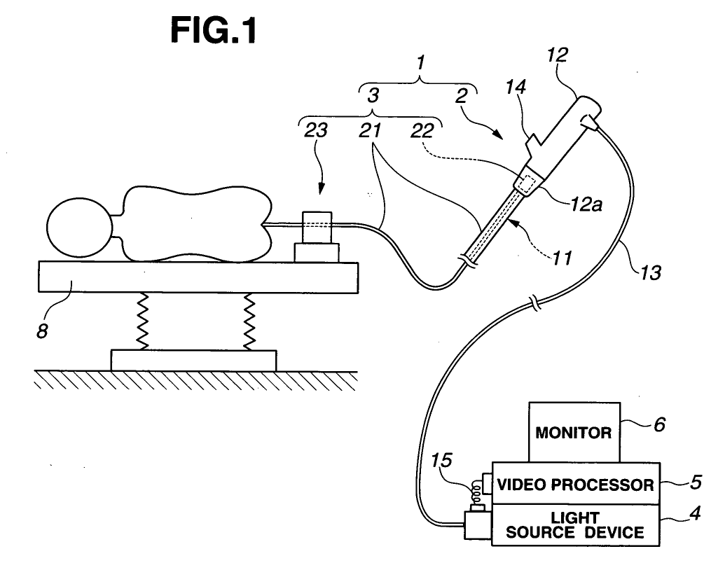

With reference to FIGS. 1 to 4, a first embodiment of the present invention will be described.

As illustrated in FIG. 1, an endoscope system 1 is configured to include an endoscope 2 and an endoscope insertion aiding device 3. The endoscope 2 includes, as external devices, a light source device 4, a video processor 5, and a monitor 6. The light source device 4 is a device for supplying illumination light to the endoscope 2. The video processor 5, which includes a signal processing circuit, supplies a drive signal for driving an image pickup device included in the endoscope 2, generates a predetermined video signal from an electronic signal which has been photoelectric-converted by and transmitted from the image pickup device, and outputs the generated video signal to the monitor 6. An endoscopic image in accordance with the video signal outputted from the video processor 5 is displayed on the screen of the monitor 6.

The endoscope 2 is configured to include an insertion portion 11, an operation portion 12, and a universal cord 13. Meanwhile, the endoscope insertion aiding device 3 is configured to include a guide tube 21, a guide tube rotating device 22, and a propulsive force generating device 23.

The insertion portion 11 illustrated in FIGS. 1 to 3 is elongated and flexible. The outer circumference of the insertion portion 11 is provided with the guide tube 2, which forms an insertion portion guiding section for propelling the insertion portion 11 toward a deep part of a body cavity with propulsive force. That is, the insertion portion 11 is covered by the guide tube 21. The outer circumferential surface of the guide tube 21 is provided with a helically shaped portion 36. The operation portion 12 is provided to the basal end side of the insertion portion 11. The guide tube rotating device 22, which is a guiding section rotating device, is provided in a bend preventing portion 12a forming a leading end-side portion of the operation portion 12 or in the operation portion 12. The guide tube rotating device 22 includes a guiding section rotating motor (hereinafter abbreviated as the rotating motor) 39, which forms rotating means for rotating the guide tube 21 in a predetermined direction around the longitudinal axis thereof. The rotating motor 39 is provided in the bend preventing portion 12a of the operation portion 12. The rotating motor 39 is a motor capable of rotating in the forward and reverse directions.

The guide tube 21 is disposed in a predetermined state in the propulsive force generating device 23 set on, for example, a bed 8 on which a patient lies. The propulsive force generating device 23 is propulsive force generating means for generating the propulsive force for moving the guide tube 21 back and forth in the direction of the longitudinal axis thereof. The universal cord 13 extends from a side portion of the operation portion 12. A basal end portion of the universal cord 13 is provided with an endoscope connector 13a connected to the light source device 4.

A reference numeral 14 denotes a treatment tool inlet, which communicates with a basal end portion of a treatment tool insertion channel 33 formed in the insertion portion 11. A reference numeral 15 denotes an electrical cable. One end portion of the electrical cable 15 is detachably connected to an electrical connector (not illustrated) provided to a side portion of the endoscope connector 13a. The other end portion of the electrical cable 15 is detachably connected to a connector portion (not illustrated) provided to the video processor 5.

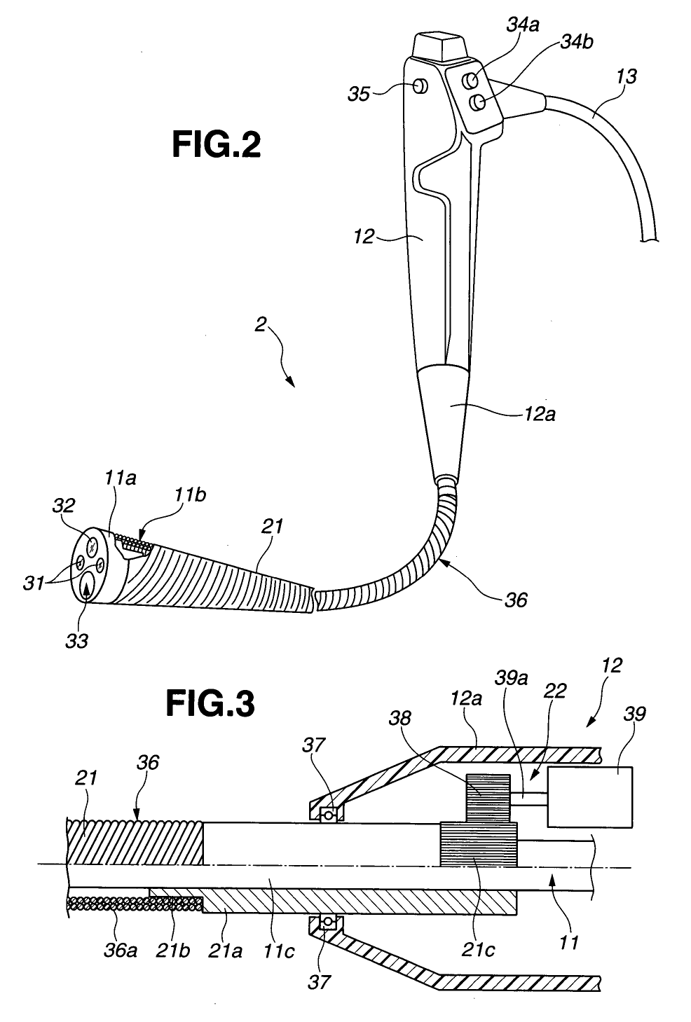

The insertion portion 11 of the endoscope 2 is formed by a rigid leading end portion 11a, a bending portion (not illustrated) configured to be bendable in, for example, the vertical and horizontal directions, and a flexible tube portion 11c having flexibility, with the respective portions connected to one another in this order from the leading end side. As illustrated in FIG. 2, a leading end surface of the rigid leading end portion 11a is formed with illumination windows 31 and an observation window 32. The illumination windows 31 form an illumination optical system, and are faced by a leading end surface of a not-illustrated light guide fiber inserted through the insertion portion 11. The observation window 32 forms an observation optical system together with the image pickup device which forms image pickup means, and is configured such that an optical image passed through the observation window 32 is formed on, for example, an image pickup surface of a CCD provided to the image pickup device. Further, the rigid leading end portion 11a is formed with an opening of the treatment tool insertion channel 33.

A side surface of the operation portion 12 is provided with, for example, two rotation start switches 34a and 34b and a stop switch 35. The rotation start switch 34a is a switch for forward movement, and causes the rotating motor 39 to rotate to thereby rotate the guide tube 21 in a predetermined direction around the longitudinal axis thereof. Meanwhile, the rotation start switch 34b is a switch for backward movement, and causes the rotating motor 39 to rotate in the reverse direction to the above-described direction. The stop switch 35 is a switch for stopping the rotating motor 39 in a rotating state.

Instead of providing the switches 34a, 34b, and 35 to the operation portion 12, a foot switch (not illustrated) may be provided as the endoscope insertion aiding device 3 so that the foot switch is used to control the rotation driving state of the rotating motor 39.

The guide tube 21 illustrated in FIGS. 2 and 3 is formed of stainless steel, for example, and is formed by helically winding a metal wire 36a of a predetermined diameter into two layers, for example, to have predetermined flexibility. The degree of closeness between turns of the helically wound metal wire 36a or the winding angle with respect to an insertion axis (hereinafter described as the helix angle) is set. With the degree of closeness between turns of the metal wire 36a or the winding angle variously set, the guide tube 21 exerting desired propulsive force can be formed. In the present embodiment, the guide tube 21 is formed by winding the metal wire 36a into a left-handed helix from the leading end to the basal end thereof. The helix angle of the guide tube 21 is set to be a constant angle from the leading end to the basal end thereof. The guide tube 21 may be formed by winding the metal wire 36a into four strands, for example.

A leading end portion of the guide tube 21 is disposed to a basal end shoulder 11b of the rigid leading end portion 11a. Meanwhile, a basal end portion of the guide tube 21 is integrally fixed to a leading end shoulder 21b of a tubular basal end portion body 21a. The basal end portion body 21a is rotatably held around the longitudinal axis thereof by, for example, a bearing 37 which is provided to an opening end portion of the bend preventing portion 12a forming the operation portion 12. The entire outer circumference of a basal end portion of the basal end portion body 21a is provided with gear grooves 21c, which forms a spur gear shape, for example.

The gear grooves 21c provided to the basal end portion body 21a mesh with a gear 38, which is fixedly provided to a motor shaft 39a of the rotating motor 39. Thus, as the rotating motor 39 is driven to rotate the motor shaft 39a, the gear 38 fixedly provided to the motor shaft 39a is also rotated. The gear 38 meshes with the gear grooves 21c provided to the basal end portion body 21a. Therefore, the guide tube 21 integrally provided to the basal end portion body 21a is rotated in the reverse direction to the rotation direction of the motor shaft 39a. The guide tube 21 is thus rotated. That is, when a user operates the rotation start switch 34a or 34b, the guide tube 21 is rotated in a predetermined direction. Then, when the user operates the stop switch 35, the rotation of the guide tube 21 is stopped.

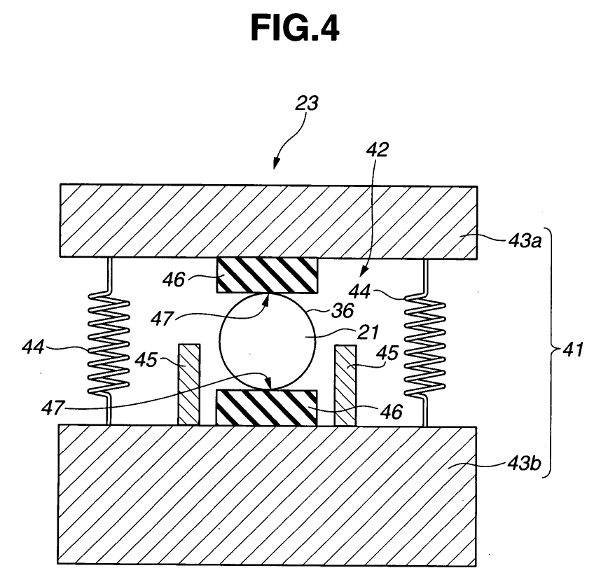

As illustrated in FIG. 4, the propulsive force generating device 23 is configured to include a nipping portion 42 for causing a device body 41 to nip the guide tube 21. The nipping portion 42 is formed by elastic members 46 provided to an upper base 43a and a lower base 43b. The elastic members 46 are formed of a rubber material, a silicon material, or the like, for example. The device body 41 includes the upper base 43a, the lower base 43b, and springs 44 which form pressing means. The upper base 43a and the lower base 43b are connected to each other by the springs 44. The lower base 43b is provided with a pair of regulating members 45, which form regulating means for regulating the position of the guide tube 21. A surface of each of the elastic members 46 is formed as a flat contact surface 47 which is made in close contact with the helically shaped portion 36 of the guide tube 21 by the pressing force of the springs 44.

FIG. 4 illustrates the configuration in which the two springs 44 are provided to connect the upper base 43a to the lower base 43b. However, the number of the springs 44 is not limited to two, but may be more than two. Further, the regulating members 45 are provided to prevent the guide tube 21 from being disposed winding in the horizontal directions and from dropping from between the elastic members 46. Accordingly, the guide tube 21 can be easily moved back and forth, with the position thereof regulated in the horizontal direction in the figure, i.e., the direction orthogonal to the direction of the longitudinal axis thereof.

When the guide tube 21 is inserted and disposed between the elastic members 46 forming the nipping portion 42, the space between the upper base 43a and the lower base 43b is increased against the pressing force of the springs 44. In the above state, the guide tube 21 is disposed between the elastic members 46. Thereby, the guide tube 21 is nipped between the flat contact surfaces 47 of the elastic members 46, and the flat contact surfaces 47 of the elastic members 46 bite into the helically shaped portion 36 of the guide tube 21. In the biting state, the helically shaped portion 36 and each of the flat contact surfaces 47 of the elastic members 46 are in contact with each other in the relationship between a male screw and a female screw. In the contact state, if the rotating motor 39 forming the guide tube rotating device 22 is rotated in the forward or reverse direction, the propulsive force for causing the male screw to move toward the female screw is generated in the contact area between the helically shaped portion 36 and each of the flat contact surfaces 47 of the elastic members 46. As a result, the guide tube 21 is moved forward or backward with respect to the direction of the longitudinal axis thereof.

The force with which the elastic members 46 forming the nipping portion 42 nip the guide tube 21, i.e., the biasing force of the springs 44 is set to be a strength enabling the operator to perform a hand operation of pushing the guide tube 21 into a body cavity against the basing force or a hand operation of drawing back the guide tube 21.

Instead of using the springs 44 in the device body 41, a weight may be provided to the upper base 43a for causing the nipping portion 42 to nip the guide tube 21. Further, instead of causing the vertically provided nipping portion 42 to nip the guide tube 21, it may be configured such that a horizontally provided nipping portion nips the guide tube 21.

The operation of the endoscope system 1 configured as described above will be described.

The operator prepares the endoscope 2 including the guide tube 21 disposed to cover the insertion portion 11, as illustrated in FIG. 2. Then, as illustrated in FIG. 1, the guide tube 21 is disposed in the nipping portion 42 of the propulsive force generating device 23, and thereafter the rigid leading end portion 11a of the endoscope 2 in an endoscopic observation state is inserted into the large intestine from the anus of the patient lying on the bed 8.

When the rigid leading end portion 11a has been inserted in the large intestine, the illumination light emitted from the illumination windows 31 formed in the rigid leading end portion 11a illuminates the interior of the large intestine. Then, an optical image of the interior of the large intestine illuminated by the illumination light is scanned by the image pickup device through the observation window 32, and an image pickup signal photoelectric-converted by the image pickup device is outputted to the video processor 5. The video processor 5 performs signal processing on the image pickup signal to generate a video signal, and outputs the generated video signal to the monitor 6. Thereby, an endoscopic image is displayed on the screen of the monitor 6.

When the operator decides to insert the insertion portion 11 toward a deep part with the use of the propulsive force, the operator operates the rotation start switch 34a, which is the switch for the forward movement provided to the operation portion 12. Then, the rotating motor 39 forming the guide tube rotating device 22 is driven to rotate, and the guide tube 21 is rotated in the left-handed direction around the longitudinal axis thereof. In the above process, the helically shaped portion 36 of the guide tube 21 is nipped by the flat contact surfaces 47 of the elastic members 46 forming the nipping portion 42, and the helically shaped portion 36 and each of the flat contact surfaces 47 are in contact with each other in the relationship between a male screw and a female screw. Therefore, the guide tube 21 moves forward with respect to the direction of the longitudinal axis thereof in such a manner that the male screw moves toward the female screw.

In the above, with the rotating motor 39 constantly rotated, the amount of propulsion of the guide tube 21 generated by the propulsive force generating device 23 is kept constant. Therefore, the guide tube 21 stably moves forward toward the deep part in the lumen at a constant speed. Then, the propulsive force of the guide tube 21 is transmitted to the rigid leading end portion 11a of the insertion portion 11 covered by the guide tube 21, and the insertion portion 11 is moved forward toward the deep part in the large intestine.

That is, while performing a hand operation, the operator introduces into the deep part in the large intestine the insertion portion 11 covered by the guide tube 21, which has received the propulsive force transmitted from the guide tube 21 and thus has obtained the propulsive force for moving forward toward the deep part in the large intestine. In the above process, the operator checks the state and the position of the insertion from the endoscopic image displayed on the screen of the monitor 6. Then, if the operator determines from the endoscopic image displayed on the monitor 6 that the rigid leading end portion 11a has reached the vicinity of the site to be observed, such as the cecum, for example, the operator operates the stop switch 35. Then, the rotation of the rotating motor 39 is stopped, and the rotation of the guide tube 21 is stopped. Thereafter, an endoscopic examination in the large intestine is performed. The operator performs the endoscopic examination while performing the operation of drawing back the insertion portion 11 covered by the guide tube 21.

During the introduction of the insertion portion 11 into the body cavity, if it is determined from the endoscopic image displayed on the monitor 6 that the leading end surface of the rigid leading end portion 11a or the like is in contact with the wall of the body cavity and thus prevents the insertion portion 11 from moving forward, the operator operates the rotation start switch 34b, which is the switch for backward movement. Then, the rotating motor 39 is rotated in the reverse direction to the above-described direction, and the insertion portion 11 is moved backward. Thereafter, the operator operates the rotation start switch 34a again to rotate the rotating motor 39 in the forward direction. Thereby, if the rigid leading end portion 11a has been in contact with the wall and thus prevented the insertion portion 11 from moving forward, the caught state is resolved when the insertion portion 11 is moved backward. When the insertion portion 11 starts to be moved forward again, the rigid leading end portion 11a is smoothly moved forward toward the deep part, with the positional relationship between the rigid leading end portion 11a and the wall slightly displaced.

In the state in which the guide tube 21 is inserted in the body cavity, the relationship of a male screw with a female screw is also established in the contact area of the helically shaped portion 36 of the guide tube 21 with the wall of the lumen. Thus, the propulsive force for moving the guide tube 21 is also generated in the contact area of the helically shaped portion 36 with the wall of the lumen. The endoscope system 1 according to the present embodiment, however, is configured such that the propulsive force for moving the guide tube 21 back and forth, which is generated in the guide tube 21 by the propulsive force generating device 23, is given priority over the propulsive force generated in the contact area of the helically shaped portion 36 with the wall of the lumen. Therefore, if the two different propulsive forces, i.e., the propulsive force generated between the helically shaped portion 36 of the guide tube 21 and the inner wall of the lumen and the propulsive force generated by the propulsive force generating device 23, are generated, the guide tube 21 is prevented from being pulled and expanded or conversely bent due to the influence of the two different propulsive forces. In the state in which the insertion portion 11 covered by the guide tube 21 is inserted into the lumen, therefore, excessive deformation of the lumen is prevented, and the insertion of the guide tube 21 is easily performed. Similarly, in the case in which the rotating motor 39 forming the guide tube rotating device 22 is rotated in the reverse direction, the propulsive force for moving the guide tube 21 backward, which is generated in the guide tube 21 by the propulsive force generating device 23, is given propriety over the propulsive force generated in the contact area of the helically shaped portion 36 with the wall of the lumen.

The insertion portion 11 provided with the guide tube 21 is inserted into the body cavity as described above. In the above process, the guide tube 21 provided to cover the insertion portion 11 is nipped by the flat contact surfaces 47 of the elastic members 46 forming the nipping portion 42 provided in the propulsive force generating device 23. Thus, the helically shaped portion 36 and each of the flat contact surfaces 47 are in the relationship between a male screw and a female screw. In the above state, the rotation start switch 34a or 34b is operated. Then, the guide tube 21 is rotated in the direction corresponding to the switching operation. Since the guide tube 21 is nipped by the nipping portion 42, the propulsive force is generated in the guide tube 21 in a similar manner to the action of screws. Then, the propulsive force is transmitted to the insertion portion 11. Accordingly, when the operator introduces the insertion portion 11 into the body cavity, the operator can easily insert the insertion portion 21 into the body cavity with the use of the propulsive force.

Further, the propulsive force generating device 23 forming the endoscope system 1 according to the present embodiment is simple in structure and does not require electric power or the like. Thus, the propulsive force generating device 23 can be configured at low cost. Furthermore, the propulsive force generating device 23 has good washability due to the simple structure thereof, and can be configured to be disposable due to the low cost configuration thereof.

In the endoscope system 1 according to the present embodiment, the guide tube rotating device 22 for rotating the guide tube 21 is configured to be included in, for example, the operation portion 12 forming the endoscope 2. However, the guide tube rotating device 22 may be configured to be provided outside the endoscope 2. In such a configuration, the externally provided guide tube rotating device 22 rotates the guide tube 21 provided to cover the insertion portion 11.

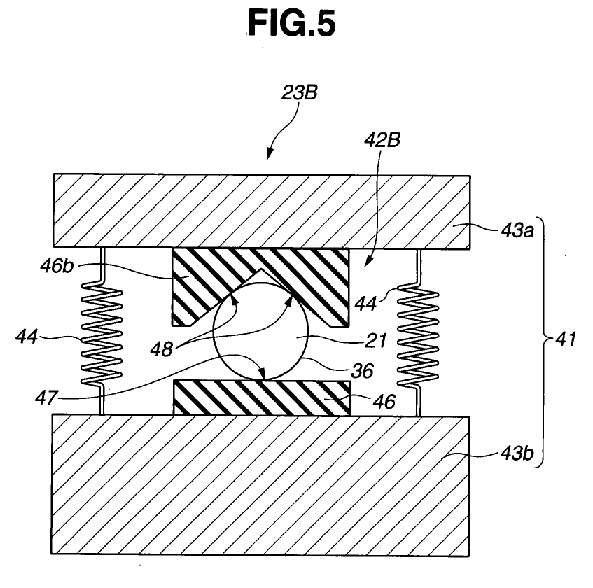

In the above-described embodiment, the elastic members 46 including the flat contact surfaces 47, which come in contact with the helically shaped portion 36 of the guide tube 21, are provided to form the nipping portion 42 of the propulsive force generating device 23. However, the configuration of the nipping portion provided in the propulsive force generating device 23 is not limited to the above-described one, but may be configurations illustrated in FIGS. 5 to 7.

In a propulsive force generating device 23B illustrated in FIG. 5, a nipping portion 42B is formed by the elastic member 46 including the flat contact surface 47, and an elastic member 46b including a pair of regulating surfaces 48 which form a pair of regulating means. The regulating surfaces 48 are formed as a concave portion having a cross section of an upside down V-shape and having an opening at the side of the flat contact surface 47 of the elastic member 46 provided on the lower base 43b.

In the present embodiment, the guide tube 21 is inserted and disposed, against the pressing force of the springs 44, between the elastic member 46 and the elastic member 46b including the regulating surfaces 48, which form the nipping portion 42B. Thus, each of the flat contact surface 47 of the elastic member 46 and the regulating surfaces 48 bite into the helically shaped portion 36 of the guide tube 21 in the relationship between a male screw and a female screw. In the present embodiment, therefore, the position of the guide tube 21 can be regulated without providing the regulating members 45 as the regulating means. The present embodiment is similar in other configurations to the above-described embodiment. According to the present configuration, similar operations and effects to those of the above-described embodiment can be obtained.

The present figure illustrates the configuration in which the elastic member 46b including the regulating surfaces 48 formed by the V-shaped concave portion is provided to the upper base 43a. However, it may be configured such that the elastic member 46b including the regulating surfaces 48 is provided to the lower base 43b or to each of the upper base 43a and the lower base 43b.

With the regulating surfaces 48 thus provided to the elastic member 46b of the nipping portion 42B, and with the regulating surfaces 48 and the flat contact surface 47 of the elastic member 46 made in contact with the helically shaped portion 36 of the guide tube 21, the position of the guide tube 21 can be reliably regulated. The present embodiment is similar in other operations and effects to the above-described embodiment.

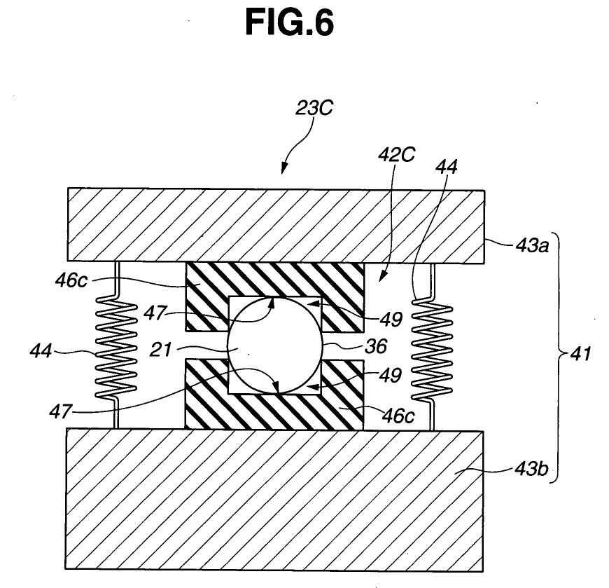

In a propulsive force generating device 23C illustrated in FIG. 6, a nipping portion 42C is formed by a pair of elastic members 46c. Each of the elastic members 46c is formed with a concave portion 49, which forms regulating means having a U-shaped cross section for preventing the guide tube 21 from dropping therefrom. The bottom surface of the concave portion 49 is formed as the flat contact surface 47. The respective elastic members 46c are fixed to the upper base 43a and the lower base 43b such that respective openings of the concave portions 49 face each other.

Thus, the guide tube 21 is inserted and disposed, against the pressing force of the springs 44, between the concave portions 49 of the elastic members 46c forming the nipping portion 42C. Thereby, most of the outer circumference of the helically shaped portion 36 of the guide tube 21 is surrounded by a pair of the concave portions 49, and the position of the guide tube 21 is regulated. The bottom surfaces of the concave portions 49 formed in the elastic members 46c are formed as the flat contact surfaces 47. Thus, each of the flat contact surfaces 47 bites into the helically shaped portion 36 in the relationship between a male screw and a female screw. That is, in the present embodiment, too, the position of the guide tube 21 can be regulated without providing the regulating members 45 as the regulating means. The present embodiment is similar in other configurations to the above-described embodiment. According to the present configuration, similar operations and effects to those of the above-described embodiment can be obtained.

It may be configured such that the width of the opening of each of the concave portions 49 is set to be larger than the diameter of the guide tube 21 to make the guide tube 21 loosely fit and disposed with respect to the width direction of the concave portions 49. With such a configuration, insertion and extraction of the guide tube 21 with respect to the elastic members 46c can be easily performed.

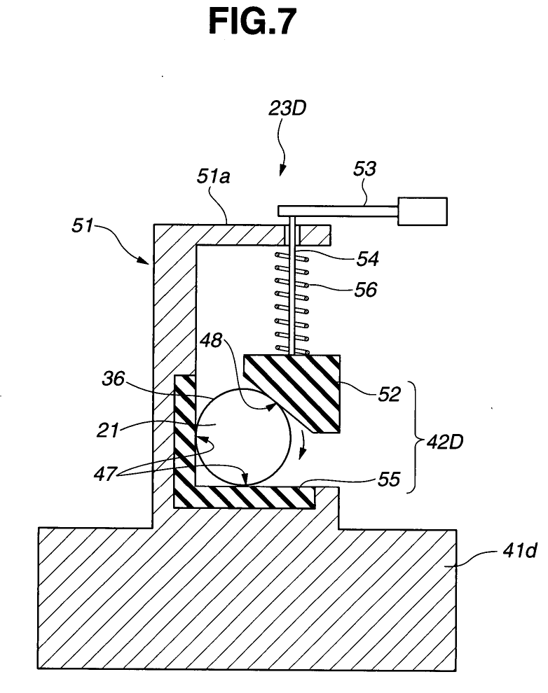

In a propulsive force generating device 23D illustrated in FIG. 7, a nipping portion 42D is formed by an L-shaped elastic member 55 having an L-shaped cross section, and a pressing elastic member 52 of a rectangular cylindrical shape having a ridge line formed with the regulating surface 48 which forms the regulating means. The L-shaped elastic member 55 is provided to a predetermined part of a base body 41d which includes a support column 51 having an arm portion 51a. Two surfaces of the L-shaped elastic member 55 are formed as a pair of the flat contact surfaces 47, which also serve as the regulating means.

Meanwhile, the pressing elastic member 52 is screwed and fixed in a predetermined state, for example, to a leading end portion of a rod portion 54 provided to the arm portion 51a. The rod portion 54 is provided with a spring 56 for biasing the pressing elastic member 52 in the direction of an arrow shown in the figure with predetermined biasing force. The rod portion 54 is provided with a handle portion 53 which is used to move the pressing elastic member 52 in the opposite direction to the direction of the arrow against the biasing force of the spring 56. The handle portion 53 is integrally provided to an end portion of the rod portion 54, for example.

Therefore, with the handle portion 53 held by a hand, the pressing elastic member 52 is moved in the opposite direction to the direction of the arrow against the biasing force of the spring 56. Thereafter, the guide tube 21 is inserted and disposed between the flat contact surfaces 47 of the L-shaped elastic member 55 and the regulating surface 48 of the pressing elastic member 52, which form the nipping portion 42D. Then, the hand is released from the handle portion 53. Thereby, the pressing elastic member 52 is moved in the direction of the arrow by the biasing force of the spring 56, and the regulating surface 48 presses the helically shaped portion 36 of the guide tube 21. Accordingly, the guide tube 21 is nipped by the pair of the flat contact surfaces 47 of the L-shaped elastic member 55 and the regulating surface 48 of the pressing elastic member 52, and the disposition position of the guide tube 21 is regulated. In the above state, each of the regulating surface 48 and the pair of the flat contact surfaces 47 bites into the helically shaped portion 36 of the guide tube 21 in the relationship between a male screw and a female screw. That is, in the present embodiment, too, the position of the guide tube 21 can be regulated without providing the regulating members 45 as the regulating means. The present embodiment is similar in other configurations to the above-described embodiment. According to the present configuration, similar operations and effects to those of the above-described embodiment can be obtained.

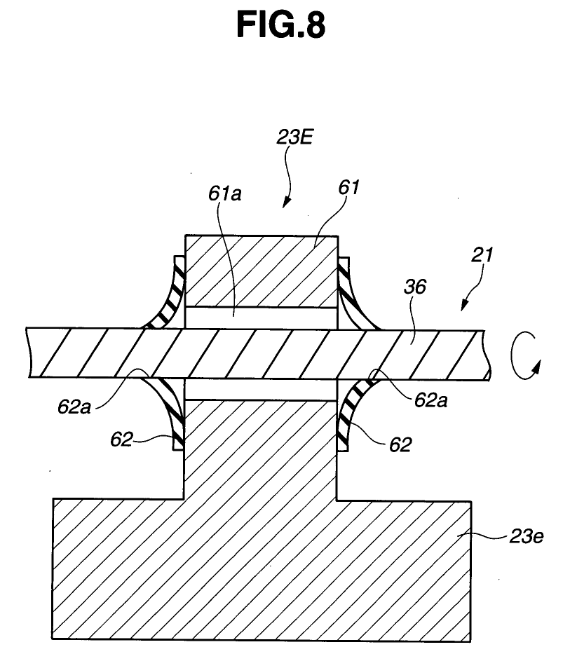

With reference to FIG. 8, a second embodiment of the present invention will be described.

In the present embodiment, a propulsive force generating device 23E forming the endoscope system 1 is different in configuration from the above-described first embodiment and other embodiments. In the propulsive force generating devices 23, 23B, 23C, and 23D of the above-described first embodiment and other embodiments, the nipping portions 42, 42B, 42C, and 42D are provided, respectively. Each of the embodiments is configured such that the guide tube 21 is nipped by the nipping portion 42, 42B, 42C or 42D to establish the relationship between a male screw and a female screw to thereby generate the propulsive force in the guide tube 21 in the direction of the longitudinal axis thereof through the action of the screws. Meanwhile, in the propulsive force generating device 23E of the present embodiment, a convex portion 61 of a device body 23e is formed with a through hole 61a or a slit, into which the guide tube 21 is inserted. Further, a flexible member 62 is provided to each of open ends of the through hole 61a. The flexible member 62 includes a contact end portion 62a which is disposed to contact the outer surface of the guide tube 21.

Specifically, as illustrated in FIG. 8, the propulsive force generating device 23E includes the device body 23e which has a cross section of an upside down T-shape. The convex portion 61 of the device body 23e is formed with the through hole 61a. The guide tube 21 is inserted and disposed in the through hole 61a. The flexible member 62 including a hole portion, for example, is provided at a predetermined position of each of the opposite openings of the through hole 61a. An edge portion of the hole portion is formed as the contact end portion 62a. The flexible member 62 is thinner than the elastic member of the first embodiment, and is formed of silicone, for example.

The guide tube 21 is disposed in the propulsive force generating device 23E through the hole portion of one of the flexible members 62, the through hole 61a formed in the device body 23e, and the hole portion of the other one of the flexible members 62. In the disposition state, as illustrated in the figure, the contact end portions 62a of the flexible members 62 come in contact with the helically shaped portion 36 of the guide tube 21 to hold the guide tube 21. Thereby, the relationship between a male screw and a female screw is established in the contact state between the helically shaped portion 36 and each of the contact end portions 62a of the flexible members 62. Accordingly, in the present embodiment, too, the guide tube 21 is provided with the propulsive force through the action of the screws.

In the state in which the contact end portions 62a come in contact with the helically shaped portion 36 and hold the guide tube 21, the helically shaped portion 36 of the guide tube 21 is inserted and disposed without coming in contact with the inner circumferential surface of the through hole 61a. That is, the through hole 61a is formed to have a diameter larger by a predetermined value than the outer diameter of the guide tube 21. Further, the holding force of the flexible members 62 for holding the helically shaped portion 36 of the guide tube 21 is smaller than the force with which the nipping portion 42 of the first embodiment nips the guide tube 21. Accordingly, the operator can easily perform the operation of pushing and pulling the guide tube 21.

The operation of the endoscope system 1 including the propulsive force generating device 23E configured as described above will be described.

The operator prepares the endoscope 2 including the guide tube 21 which covers the insertion portion 11. Then, with the guide tube 21 inserted and disposed through the through hole of the propulsive force generating device 23E, the leading end portion of the endoscope 2 in the endoscopic observation state is inserted into the large intestine from the anus of the patient lying on the bed.

When the operator decides to insert the insertion portion 11 toward a deep part with the use of the propulsive force, the operator operates the rotation start switch 34a provided to the operation portion 12 to drive to rotate the rotating motor 39. Then, the guide tube 21 is rotated in the left-handed direction around the longitudinal axis thereof. In the above process, the helically shaped portion 36 of the guide tube 21 is in contact with each of the contact end portions 62a of the flexible members 62 provided to the propulsive force generating device 23E in the relationship between a male screw and a female screw. Thus, the propulsive force for moving the male screw toward the female screw is generated, and the guide tube 21 is moved forward in the direction of the longitudinal axis thereof. Thereby, similar operations to those of the above-described first embodiment can be obtained.

Accordingly, the endoscope system of the second embodiment can obtain similar effects to those of the above first embodiment. Further, in the present embodiment, the contact state of the contact end portions 62a with respect to the helically shaped portion 36 can be changed by suitably setting the diameter of the hole portion formed in each of the flexible members 62. Therefore, setting and control of the nipping force can be more easily performed, and thus the amount of propulsion can be stabilized. Further, since the flexible members 62 and the like are simple in configuration, the present embodiment is easily manufactured and configured at low cost.

FIG. 8 illustrates the configuration in which one sheet of the flexible member 62 is disposed to each of the opposite end openings of the through hole 61a of the device body 23e. However, the configuration is not limited to the above one. Thus, it may be configured, for example, such that only one sheet of the flexible member 62 is provided to one of the openings, or that a plurality of the flexible members are provided to at least one of the openings, with the pitch of the helically shaped portion 36 taken into account.

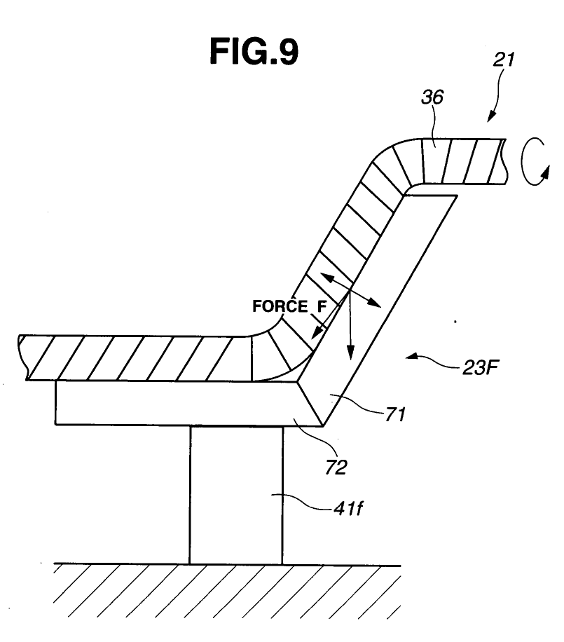

With reference to FIGS. 9 to 11, a third embodiment of the present invention will be described.

In the above-described embodiments, the propulsive force generating device 23 is configured such that the helically shaped portion 36 of the guide tube 21 is pressed against the elastic members or made in contact with the flexible members to establish the relationship between a male screw and a female screw in the contact area between the helically shaped portion 36 and each of the elastic members or in the contact area between the helically shaped portion 36 and each of the flexible members to thereby generate the propulsive force in the guide tube 21 through the action of the screws. Meanwhile, in the third embodiment, the self weight of the insertion portion 11 and the guide tube 21 acting downward in the vertical direction is converted into the propulsive force.

As illustrated in FIG. 9, a propulsive force generating device 23F forming the endoscope system 1 according to the present embodiment is formed into a chair shape, with a device body 41f provided with a slope portion 71 and a horizontal portion 72. Thus, the guide tube 21 disposed on the device body 41f is bent. The device body 41f, the slope portion 71, and the horizontal portion 72 are formed of a metal, a plastic, or the like.

The slope portion 71 converts the self weight of the insertion portion 11 covered by the guide tube 12, which acts downward in the vertical direction, into the propulsive force acting in the direction of the longitudinal axis of the insertion portion 11 to thereby generate the propulsive force with respect to the direction of the longitudinal axis. Meanwhile, the horizontal portion 72 forms a support portion for supporting the guide tube 21, which is provided with the propulsive force in the direction of the longitudinal axis thereof by the slope portion 71, with respect to the horizontal direction.

The operation of the propulsive force generating device 23F configured as described above will be described.

The guide tube 21 covering the insertion portion 11 is disposed on the slope portion 71 and the horizontal portion 72 of the propulsive force generating device 23F. In the above process, the operator holds the guide tube 21 such that a part of the guide tube 21 located between the propulsive force generating device 23F and the patient is bent to some degree. Further, the guide tube 21 is disposed such that the self weight of the insertion portion 11 and the guide tube 21 is placed on the slope portion 71. Thereby, force F, which is the propulsive force caused by the reaction force from the slope portion 71 against the self weight of the insertion portion 11 and the guide tube 21 through the gravitational action, is generated in the slope portion 71 of the propulsive force generating device 23F. Since the guide tube 21 covering the insertion portion 11 is disposed on the horizontal portion 72 of the propulsive force generating device 23F, the force F for moving the insertion portion 11 and the guide tube 21 forward in the horizontal direction acts on the insertion portion 11 and the guide tube 21.

That is, with the guide tube 21 covering the insertion portion 11 disposed on the propulsive force generating device 23F, the propulsive force caused by the reaction force from the slope portion 71 is constantly stably provided to the insertion portion 11 and the guide tube 21. Therefore, when the rigid leading end portion 11a of the endoscope 2 is inserted into the large intestine from the anus of the patient with the guide tube 21 disposed on the propulsive force generating device 23F, the operator can easily insert the insertion portion 11 toward the deep part, as the propulsive force provided to the insertion portion 11 and the guide tube 21 aids the forward movement of the insertion portion 11.

In the present embodiment, with the guide tube 21 inserted in the large intestine, the rotating motor 39 of the guide tube rotating device 22 is driven to rotate to thereby rotate the guide tube 21 in a predetermined direction around the longitudinal axis thereof. Since the relationship between a male screw and a female screw is established in the contact area between the helically shaped portion 36 and the internal wall of the lumen, the propulsive force is generated in the guide tube 21 through the action of the screws. Accordingly, the insertion portion 11 is further smoothly moved forward.

With the guide tube 21 covering the insertion portion 11 thus disposed on the slope portion 71, the self weight of the insertion portion 11 and the guide tube 21 is converted into the propulsive force, and the propulsive force used to insert the insertion portion 11 into the body cavity can be obtained.

Further, with the guide tube held bent to some degree such that guide tube 21 is displaced to place the self weight thereof on the slope portion 71 of the propulsive force generating device 23F, constant propulsive force can be constantly obtained irrespective of the diameter of the guide tube 21. In the propulsive force generating device 23F, the guide tube 21 is not nipped by the elastic members. Thus, there is no ablation of the elastic members.

The medical instrument disposed on the propulsive force generating device 23F is not limited to the guide tube for covering the insertion portion of the endoscope, as described above. Thus, the medical instrument may be, for example, a guide tube or the like of a small diameter inserted through the treatment tool insertion channel formed in the insertion portion of the endoscope.

Further, in the propulsive force generating device 23F, an elastic sheet member may be applied to the surface of the slope portion 71 and the horizontal portion 72, on which the guide tube 21 is disposed. With such a configuration, the relationship between a male screw and a female screw is established in the contact area between the helically shaped portion 36 of the guide tube 21 and elastic sheet member. Thus, when the guide tube 21 is rotated, the propulsive force caused by the action of the screws can be obtained in addition to the propulsive force obtained by the slope portion 71.

Furthermore, a regulating member (not illustrated) for regulating the position of the guide tube 21 may be provided to at least one of the slope portion 71 and the horizontal portion 72 of the propulsive force generating device 23F. With such a configuration, the guide tube 21 is disposed with no misalignment.

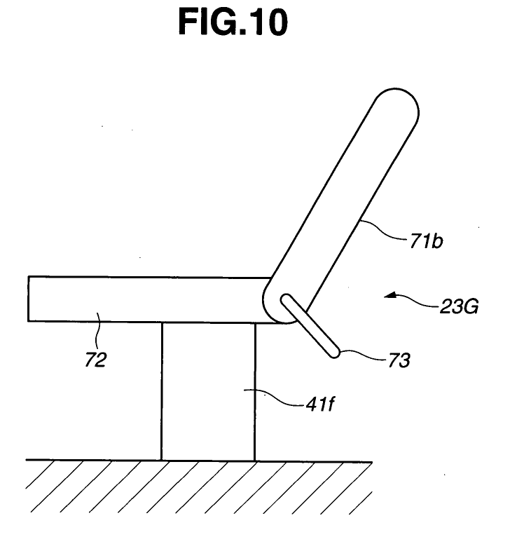

Further, as illustrated in FIG. 10, an adjusting lever 73 enabling adjustment of the flexion angle formed by the slope portion 71 and the horizontal portion 72 may be provided to form a propulsive force generating device 23G. The propulsive force generating device 23G illustrated in the figure is provided with the adjusting lever 73 for adjusting the flexion angle formed by the slope portion 71 and the horizontal portion 72, i.e., the tilt angle of a slope portion 71b. Therefore, the tilt angle of the slope portion 71b can be adjusted to a desired angle. With such a configuration, when the guide tube 21 is disposed on the propulsive force generating device 23G, the propulsive force provided to the guide tube 21 can be adjusted to a desired degree.

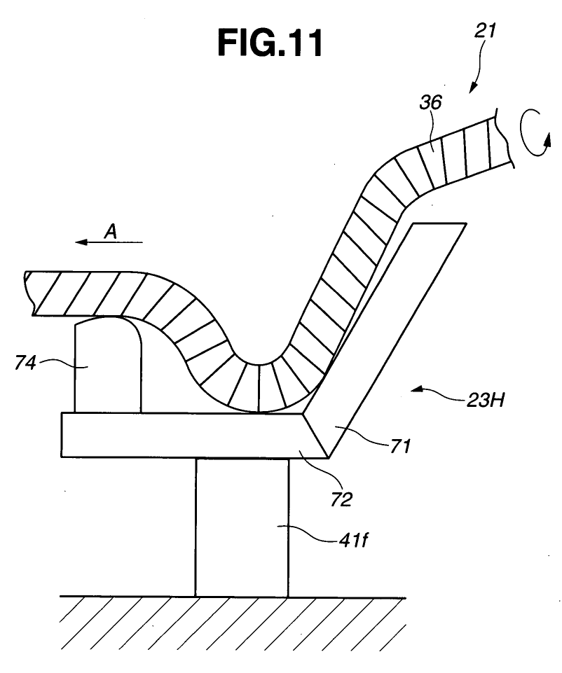

Furthermore, as illustrated in FIG. 11, a bend generating stage 74 for causing a bend in a part of the guide tube 21 may be provided to the horizontal portion 72 to form a propulsive force generating device 23H. In the propulsive force generating device 23H illustrated in the figure, the bend generating stage 74 for bending the guide tube 21 into a desired shape is provided at a predetermined position of the horizontal portion 72. The bend generating stage 74 is set to have a predetermined height, and is fixedly or movably provided to a surface of the horizontal portion 72 on which the guide tube is disposed.

With the bend generating stage 74 thus provided to the propulsive force generating device 23H, a part of the guide tube 21 is bent when the guide tube 21 is disposed on the propulsive force generating device 23H. Thereby, the above-described force F caused by the reaction force from the slope portion 71 against the self weight of the guide tube 21, and the force acting in the direction of an arrow A shown in the figure, which includes the force for returning the bent guide tube 21 into a linear shape, i.e., the restoring force, are generated in the guide tube 21. That is, with the guide tube 21 bent disposed on the propulsive force generating device 23H, the force A caused by the restoring force with which the guide tube 21 returns to the linear shape, and the force F are provided as the propulsive force for moving the guide tube 21 forward. Accordingly, the propulsive force provided to the guide tube 21 is increased.

In the above-described guide tube 21, the helix angle of the helically shaped portion 36 is kept constant. In forming a guide tube, however, it is presumable to form one guide tube by connecting two or more guide tubes of different helix angles.

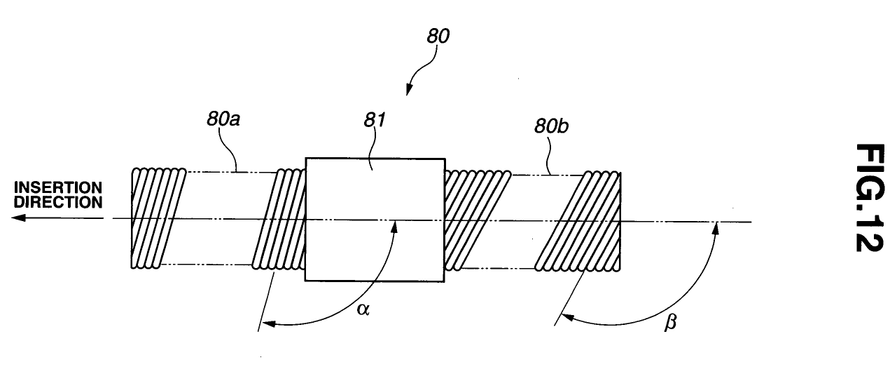

For example, a guide tube 80 illustrated in FIG. 12 is formed by a first guide tube 80a having a helix angle α with respect to the insertion axis thereof, a second guide tube 80b having a helix angle β with respect to the insertion axis thereof, and a pipe-shaped connecting member 81 for connecting the first guide tube 80a to the second guide tube 80b. The connecting member 81 is formed of a metal such as stainless steel or a flexible member such as rubber, and is integrally fixed by soldering or adhesive bonding.

In the guide tube 80, the first guide tube 80a and the second guide tube 80b are different in the helix angle. Thus, even if one of the guide tubes does not properly mesh with the propulsive force generating device, the other one of the guide tubes can properly mesh with the propulsive force generating device. Therefore, the guide tube 80 can obtain stable propulsive force.

Further, the guide tube 80 is formed by providing the first guide tube 80a on the side of the insertion direction thereof and the second guide tube 80b on the side of the basal end thereof. In the above configuration, the helix angles α and β are set to have the relationship α<β.

Accordingly, when the guide tube 80 is rotated through 360°, the traveling distance (the amount of propulsion) is greater in the second guide tube 80b than in the first guide tube 80a. Therefore, the pressing force (the propulsive force) toward the first guide tube 80a (toward the insertion direction) constantly acts.

As a result, in the guide tube 80, when the first guide tube 80a disposed on the leading end side is caught by or is not properly meshed with the propulsive force generating device and thus is rotated idly to some extent, such a caught state or idle rotation is resolved by the pressing force toward the insertion direction. Thus, the guide tube 80 can be stably inserted into the body cavity. Further, the propelling speed (the propulsive force) can be arbitrarily set.

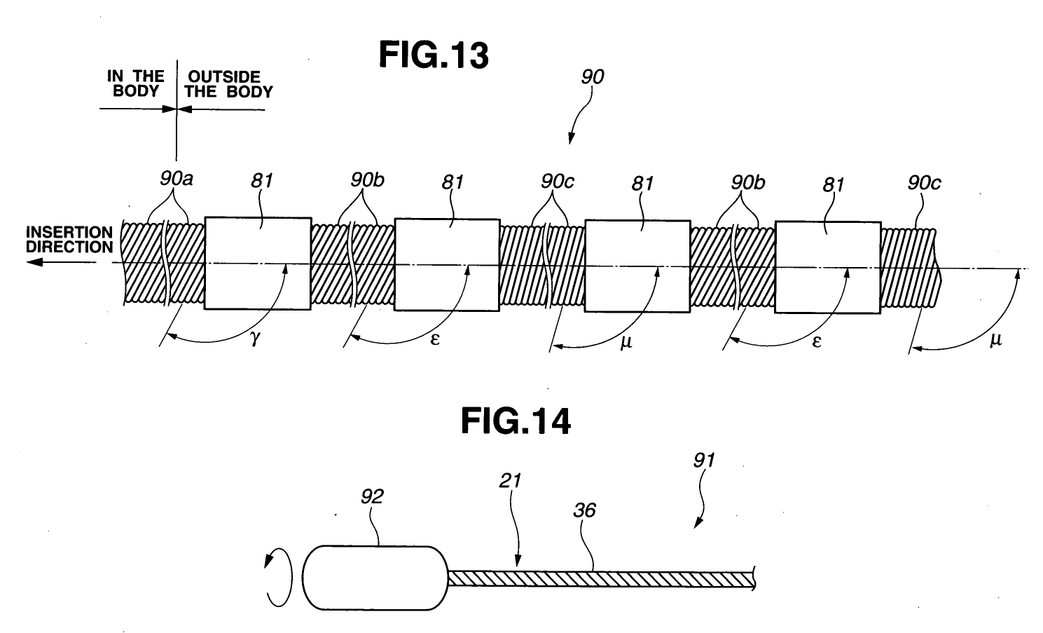

Meanwhile, in a guide tube 90 illustrated in FIG. 13, the helix angle of a guide tube inserted into the body cavity is set to be different from the helix angle of a guide tube disposed outside the body. Specifically, the guide tube 90 is configured to include an intracavital guide tube 90a, which is inserted into the body cavity, and a first extracorporeal guide tube 90b, a second extracorporeal guide tube 90c, and the connecting member 81, which are disposed outside the body. In an extracorporeal part of the guide tube 90, the first extracorporeal guide tube 90b and the second extracorporeal guide tube 90c are alternately connected to each other by the connecting member 81.

The intracavital guide tube 90a, the first extracorporeal guide tube 90b, and the second extracorporeal guide tube 90c have helix angles γ, ρ, and μ, respectively, with respect to the insertion axis thereof. The relationship among the helix angles of the intracavital guide tubes 90a, 90b, and 90c is set to be μ<γ<ρ.

That is, in the guide tube 90, the helix angle γ of the intracavital guide tube 90a inserted in the body cavity is set to be an intermediate value. Further, the helix angles ρ and μ of the first extracorporeal guide tube 90b and the second extracorporeal guide tube 90c, which are disposed outside the body, are set to be a large value and a small value, respectively. According to the thus configured guide tube 90, the propulsive force (the amount of propulsion) can be changed, and the helix angles of the respective guide tubes form the propulsive force changing means.

Therefore, when the intracavital guide tube 90a is disposed with respect to the propulsive force generating device, the guide tube 90 is inserted into the body cavity with an intermediate amount of propulsion. Thereafter, the first extracorporeal guide tube 90b and the second extracorporeal guide tube 90c are alternately disposed with respect to the propulsive force generating device. When the first extracorporeal guide tube 90b is disposed with respect to the propulsive force generating device, the guide tube 90 is provided with large propulsive force. Meanwhile, when the second extracorporeal guide tube 90c is disposed with respect to the propulsive force generating device, the guide tube 90 is provided with small propulsive force. That is, with the first extracorporeal guide tube 90b and the second extracorporeal guide tube 90c, which are the extracorporeal part of the guide tube 90, alternately disposed with respect to the propulsive force generating device, the guide tube 90 can be inserted into the body cavity with amount of propulsion alternating between a large amount and a small amount.

The present embodiment is not limited to the configuration in which the insertion portion 11 is covered by the guide tube 21, and thus may be configured, for example, such that the leading end of the guide tube 21 including the helically shaped portion 36 is provided with a capsule endoscope, or that the guide tube or the like is used inserted through the treatment tool insertion channel of the endoscope.

FIG. 14 illustrates an observation device. An observation device 91 illustrated in the figure is provided with a capsule 92 at the leading end side of the guide tube 21 including the helically shaped portion 36. The capsule 92 includes therein a not-illustrated image pickup device which forms an illumination optical system or an image pickup optical system. A signal cable or the like extending from the image pickup device is inserted through the guide tube 21. The observation device 91 is configured to be rotated in a predetermined direction around the longitudinal axis thereof by a guide tube rotating device (not illustrated) separately or integrally provided to the observation device 91.

As described in the above first to third embodiments, the observation device 91 is configured to be inserted into a deep part of a body cavity, provided with the propulsive force in the direction of the longitudinal axis thereof by the propulsive force generating device. Further, the observation device 91 can be moved backward by rotating the rotating motor of the guide tube rotating device in the reverse direction. If the capsule 92 is configured to be a wireless communication type, the signal cable becomes unnecessary.

The present invention is not limited only to the embodiments described above, but various modifications can be made in the present invention within a scope not departing from the gist of the invention.

What is claimed is:

1. An insertion device comprising:
a flexible insertion portion guiding section formed with a helically shaped portion around the outer circumferential surface thereof;
a guiding section rotating device for rotating the insertion portion guiding section in a predetermined direction around the longitudinal axis thereof; and
a propulsive force generating device for generating propulsive force in the insertion portion guiding section in the direction of the longitudinal axis of the insertion portion guiding section.

2. An insertion device comprising:
an elongated and flexible insertion portion;
a flexible insertion portion guiding section formed with a helically shaped portion around the outer circumferential surface thereof, and disposed around the outer circumference of the insertion portion;
a guiding section rotating device for rotating the insertion portion guiding section in a predetermined direction around the longitudinal axis thereof; and
a propulsive force generating device for generating propulsive force in the insertion portion guiding section in the direction of the longitudinal axis of the insertion portion guiding section.

3. The insertion device according to claim 1,
wherein the propulsive force generating device includes a nipping portion, which nips the insertion portion guiding section, and which, when the insertion portion guiding section is rotated in the predetermined direction around the longitudinal axis thereof, generates the propulsive force with respect to the direction of the longitudinal axis of the insertion portion guiding section through the action of screws.

4. The insertion device according to claim 2,
wherein the propulsive force generating device includes a nipping portion, which nips the insertion portion guiding section, and which, when the insertion portion guiding section is rotated in the predetermined direction around the longitudinal axis thereof, generates the propulsive force with respect to the direction of the longitudinal axis of the insertion portion guiding section through the action of screws.

5. The insertion device according to claim 1,
wherein the propulsive force generating device includes a through hole or a slit in which the insertion portion guiding section is inserted, and a flexible member disposed to contact the outer surface of the insertion portion guiding section disposed in the through hole or the slit, and wherein, when the insertion portion guiding section is rotated in the predetermined direction around the longitudinal axis thereof, the propulsive force generating device generates the propulsive force with respect to the direction of the longitudinal axis of the insertion portion guiding section through the action of screws.

6. The insertion device according to claim 2,
wherein the propulsive force generating device includes a through hole or a slit in which the insertion portion guiding section is inserted, and a flexible member disposed to contact the outer surface of the insertion portion guiding section disposed in the through hole or the slit, and wherein, when the insertion portion guiding section is rotated in the predetermined direction around the longitudinal axis thereof, the propulsive force generating device generates the propulsive force with respect to the direction of the longitudinal axis of the insertion portion guiding section through the action of screws.

7. The insertion device according to claim 1,
wherein the propulsive force generating device includes
a slope portion for converting the self weight of the insertion portion guiding section into the propulsive force in the direction of the longitudinal axis thereof to generate the propulsive force with respect to the direction of the longitudinal axis of the insertion portion guiding section; and
a horizontal portion for supporting in the horizontal direction the insertion portion guiding section provided with the propulsive force by the slope portion.

8. The insertion device according to claim 2,
wherein the propulsive force generating device includes
a slope portion for converting the self weight of the insertion portion guiding section into the propulsive force in the direction of the longitudinal axis thereof to generate the propulsive force with respect to the direction of the longitudinal axis of the insertion portion guiding section; and
a horizontal portion for supporting in the horizontal direction the insertion portion guiding section provided with the propulsive force by the slope portion.
